(19) United States
(12) Patent Application Publication
(10) Pub. No.: US 2021/0329073 A1
(43) Pub. Date: Oct. 21, 2021

(54) METHOD AND APPARATUS FOR CONTEXT EXTENSION BETWEEN IOT DEVICES

(71) Applicant: Samsung Electronics Co., Ltd., Suwon-si, Gyeonggi-do (KR)

(72) Inventors: Harit SHARMA, Bangalore (IN); Nabeel Mohamed C. L., Bangalore (IN)

(21) Appl. No.: 16/618,991

(22) PCT Filed: Jun. 4, 2019
(86) PCT No.: PCT/KR2019/006716

§ 371 Date: Dec. 3, 2019

(30) Foreign Application Priority Data
Jun. 8, 2018 (IN) 201841021485
Feb. 21, 2019 (IN) 2018 41021485

(51) Int. Cl. H04L 29/08; G16Y 40/35; H04M 1/725

(52) U.S. Cl. CPC H04L 67/12; H04L 67/22; H04M 1/725; G16Y 40/35; H04L 67/34

(57) ABSTRACT

There is provided a context extension apparatus for context extension between Internet of Things (IoT) devices, the context extension apparatus including: a memory storing one or more instructions; and at least one processor configured to execute the one or more instructions stored in the memory, wherein the at least one processor is further configured to receive context information from a context information generation apparatus, determine a context extension action based on the received context information and a context extension trigger event in response to an occurrence of the context extension trigger event, and allow the determined context extension action to be performed.

### TECHNICAL FIELD

The present disclosure relates to a method and an apparatus for context extension between Internet of Things (IoT) devices.

### BACKGROUND ART

Recently, along with the development of Internet of Things (IoT) technology, many IoT devices are being used. Accordingly, there is demand for a context extension technique among a plurality of IoT devices. Unlike conventional rule-based smart systems, artificial intelligence (AI) systems get smarter while a machine is self-training and self-determining. The more an AI system is used, the more improved the AI system's recognition rate is and the more it can accurately understand user taste, and thus, conventional rule-based smart systems are being gradually replaced with deep learning-based AI systems. AI technology includes machine training (deep learning) and element technologies using the machine training. Machine training is an algorithm technology of self-classifying/self-training features of input data, and element technologies are technologies utilizing a machine training algorithm such as deep learning and include technical fields such as linguistic understanding, visual understanding, inference/prediction, knowledge representation, and motion control.

### DESCRIPTION OF EMBODIMENTS

### Technical Problem

An embodiment of the present disclosure enables context extension between Internet of Things (IoT) devices to be performed.

### Solution to Problem

According to an embodiment of the present disclosure, there is provided a context extension apparatus for context extension between Internet of Things (IoT) devices, the context extension apparatus including: a memory storing one or more instructions; and at least one processor configured to execute the one or more instructions stored in the memory, wherein the at least one processor is further configured to receive context information from a context information generation apparatus, determine a context extension action based on the received context information and a context extension trigger event in response to an occurrence of the context extension trigger event, and allow the determined context extension action to be performed.

According to another embodiment of the present disclosure, there is provided a context information generation apparatus for context extension between Internet of Things (IoT) devices, the context information generation apparatus including: a memory storing one or more instructions; and at least one processor configured to execute the one or more instructions stored in the memory, wherein the at least one processor is further configured to generate context information based on a current state of the context information generation apparatus and transmit the generated context information to a context extension apparatus.

According to another embodiment of the present disclosure, there is provided an operating method of a context extension apparatus for context extension between Internet of Things (IoT) devices, the operating method including: receiving context information from a context information generation apparatus; determining a context extension action based on the received context information and a context extension trigger event in response to an occurrence of the context extension trigger event; and allowing the determined context extension action to be performed.

According to another embodiment of the present disclosure, there is provided an operating method of a context information generation apparatus for context extension between Internet of Things (IoT) devices, the operating method including: generating context information based on a current state of the context information generation apparatus; and transmitting the generated context information to a context extension apparatus.

According to another embodiment of the present disclosure, there is provided a program stored in a recording medium to execute, in a computer, the method according to an embodiment of the present disclosure.

According to another embodiment of the present disclosure, there is provided a computer-readable recording medium having recorded thereon a program for executing, in a computer, the method according to an embodiment of the present disclosure.

### Advantageous Effects of Disclosure

According to an embodiment of the present disclosure, context extension between Internet of Things (IoT) devices can be performed.

### BRIEF DESCRIPTION OF DRAWINGS

FIG. 1 is a schematic block diagram of a context extension apparatus according to an embodiment of the present disclosure.

FIG. 2 is a schematic block diagram of a context information generation apparatus according to an embodiment of the present disclosure.

FIG. 3 is a schematic flowchart of an operating method of a context information generation apparatus, according to an embodiment of the present disclosure.

FIG. 4 is a schematic flowchart of an operating method of a context extension apparatus, according to an embodiment of the present disclosure.

FIG. 5 illustrates an operation of a context extension apparatus, according to an embodiment of the present disclosure.

FIG. 6 illustrates an operation of a context extension system, according to an embodiment of the present disclosure.

FIG. 7A illustrates a taxi reservation scenario according to an embodiment of the present disclosure.

FIG. 7B illustrates a taxi reservation scenario according to an embodiment of the present disclosure.

FIG. 7C illustrates a sneakers purchase scenario according to an embodiment of the present disclosure.

FIG. 7D illustrates a video product payment scenario according to an embodiment of the present disclosure.

FIG. 7E illustrates a movie purchase scenario according to an embodiment of the present disclosure.

FIG. 7F illustrates a toll payment scenario according to an embodiment of the present disclosure.

FIG. 7G illustrates a chat window opening scenario according to an embodiment of the present disclosure.

FIG. 8 is a block diagram of an apparatus for managing a context aware interaction between Internet of Things (IoT) devices in an IoT environment, according to an embodiment of the present disclosure.

FIG. 9 is a detailed block diagram of a processing module shown in FIG. 8, including various modules, according to an embodiment of the present specification.

FIG. 10 is a block diagram of a system for managing a context aware interaction between IoT devices in an IoT environment, according to an embodiment of the present specification.

FIG. 11A is a block diagram of a method of analyzing context meta-data, according to an embodiment of the present specification.

FIG. 11B is a block diagram of a method of determining a regular user interaction with an IoT device, according to an embodiment of the present specification.

FIG. 12 illustrates a context continuity framework for managing a context aware interaction between IoT devices in an IoT environment, according to an embodiment of the present specification.

### MODE OF DISCLOSURE

Hereinafter, embodiments of the present disclosure will be described in detail with reference to the accompanying drawings such that those of ordinary skill in the art to which the present disclosure belongs could easily carry out the embodiments. However, the present disclosure could be implemented in various different forms and is not limited to the embodiments described herein. Specific executions described in the present disclosure are only illustrative and do not limit the scope of the present disclosure even in any method. For conciseness of the specification, disclosure of conventional electronic configurations, control systems, software, and other functional aspects of the systems may be omitted.

In addition, in the drawings, parts irrelevant to the description are omitted to clearly describe the present disclosure, and like reference numerals denote like elements throughout the specification. Connection lines or connection members between components shown in the drawings illustrate functional connections and/or physical or circuit connections. The connections between components can be represented by replaceable or additional various functional connections, physical connections, or circuit connections in an actual apparatus.

The terms used in this specification are those general terms currently widely used in the art, but the terms may vary according to the intention of those of ordinary skill in the art, precedents, or new technology in the art. Thus, the terms used in the present disclosure should be understood not as simple names but based on the meaning of the terms and the overall description. In addition, although terms, such as ‘first’ and ‘second’, can be used to describe various elements, the elements cannot be limited by the terms. The terms can be used to classify a certain element from another element. The wording “according to an embodiment” appearing in various points of the present disclosure does not necessarily indicate the same embodiment. In addition, in the present disclosure, a case of “at least one of a, b, or c” may include the selection of the first option a, the selection of the second option b, the selection of the third option c, the selection of the first and second options a and b, the selection of the second and third options b and c, the selection of the first and third options a and c, or the selection of the three options a, b, and c.

An embodiment of the present disclosure can be represented with functional blocks and various processing steps. Some or all of these functional blocks can be implemented by various numbers of hardware and/or software configurations for executing specific functions. For example, the functional blocks in the present disclosure may be implemented by one or more microprocessors or by circuit configurations for a predetermined function. In addition, for example, the functional blocks in the present disclosure may be implemented by various programming or scripting languages. The functional blocks may be implemented by an algorithm executed by one or more processors. In addition, the present disclosure may employ the prior art for electronic environment configuration, signal processing, and/or data processing.

In the description of the present disclosure, when it is determined that a specific description of relevant well-known functions or components may obscure the essentials of the present disclosure, a detailed description thereof is omitted. For convenience of description, both an apparatus and a method are described if necessary.

Hereinafter, the present disclosure will be described in detail with reference to the accompanying drawings.

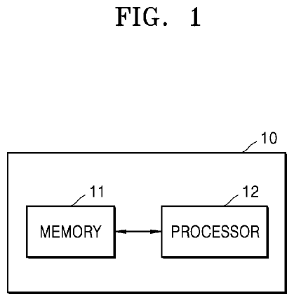

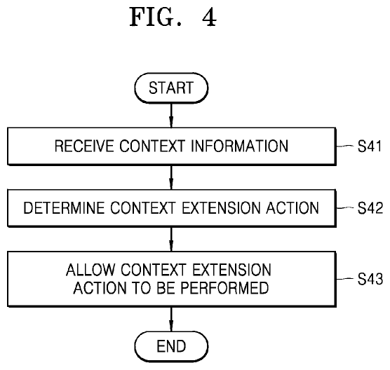

FIG. 1 is a schematic block diagram of a context extension apparatus according to an embodiment of the present disclosure. Referring to FIG. 1, a context extension apparatus 10 according to an embodiment of the present disclosure may include a memory 11 storing one or more instructions and a processor 12 configured to execute the one or more instructions stored in the memory 11. The context extension apparatus 10 may be a communicable Internet of Things (IoT) device. IoT devices may include various devices such as a smartphone, a wearable device, a tablet computer, a laptop computer, a desktop computer, a workstation, a server, a smart speaker, a home appliance, a piece of furniture, health equipment, a security device, a sensor, a meter, a robot, a business machine, medical equipment, a production device, and a transportation means. The IoT devices may include various kinds of devices used for home or building automatic systems, various types of industry automatic systems for business, agriculture, manufacturing, distribution, sales, traffic, finance, and the like, energy or environment systems, smart cities, and the like. Hereinafter, the term ‘device’ may include an IoT device unless it is defined differently. The memory 11 may indicate a single memory or a plurality of memories. The processor 12 may indicate a single processor or a plurality of processors. An operation of the processor 12 will be described in detail with reference to FIG. 4 and the like.

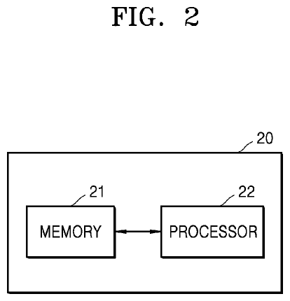

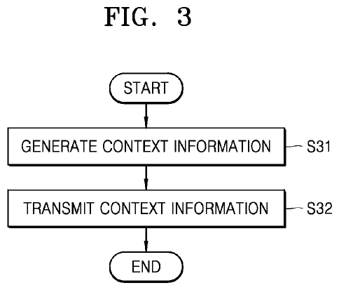

FIG. 2 is a schematic block diagram of a context information generation apparatus according to an embodiment of the present disclosure. Referring to FIG. 2, a context information generation apparatus 20 according to an embodiment of the present disclosure may include a memory 21 storing one or more instructions and a processor 22 configured to execute the one or more instructions stored in the memory 21. The context information generation apparatus 20 may be a communicable IoT device. The memory 21 may indicate a single memory or a plurality of memories. The processor 22 may indicate a single processor or a plurality of processors. An operation of the processor 22 will be described in detail with reference to FIG. 3 and the like.

FIG. 3 is a schematic flowchart of an operating method of a context information generation apparatus, according to an embodiment of the present disclosure. Referring to FIG. 3, the processor 22 of the context information generation apparatus 20 may generate context information based on a current state of the context information generation apparatus 20 in operation S31 and transmit the generated context information to the context extension apparatus 10 in operation S32.

The context information indicates information indicating a current state of the context information generation apparatus 20. For example, the context information may indicate an idle state of a computer, a state in which a specific notification or no notification is popped up on a smart watch, a state in which specific content is played on a television (e.g., a state of playing an interstitial advertisement, a state of playing an advertisement for a specific product, a state of playing a trailer of a specific film, or a state of playing a screen image including a specific product), a state in which a smartphone is placed without any operation, a state in which a smartphone is in a pocket or a bag, a state in which a specific application is being executed in a tablet computer, a state in which a mobile device is moving at a high speed, a state in which a washing machine has completed washing, a state in which a living room lamp is turned on, a state in which an air cleaner senses a high air pollution level, or the like. The context information may be information indicating a set or a combination of a plurality of individual states.

The transmission of the context information to the context extension apparatus 10 may indicate transmitting the context information by assigning at least one device as a destination, or transmitting the context information to a random device without assigning a destination. The transmission of the context information to the context extension apparatus 10 may indicate broadcasting the context information. The broadcasting may indicate transmitting the context information to all devices capable of receiving data in a specific communication scheme. The broadcasting may indicate transmitting the context information to all devices in a broadcast domain. The broadcasting may indicate transmitting the context information to all devices existing nearby by using short-range communication. The broadcasting may indicate advertising. For example, the transmission of the context information to the context extension apparatus 10 may indicate broadcasting the context information by using Wi-Fi, Bluetooth, Bluetooth low energy (BLE), ultrasound communication, optical wireless communication (OWC), or the like.

The transmission of the context information from the context information generation apparatus 20 to the context extension apparatus 10 may indicate transmitting the context information to a device registered to a same user to which the context information generation apparatus 20 is registered, or transmitting the context information to a random device regardless of user registration. The transmission of the context information from the context information generation apparatus 20 to the context extension apparatus 10 may indicate transmitting the context information to a device which is not registered to a same user to which the context information generation apparatus 20 is registered. The transmission of the context information from the context information generation apparatus 20 to the context extension apparatus 10 may indicate transmitting the context information to a device registered in the same group in which the context information generation apparatus 20 is registered, or transmitting the context information to a random device regardless of group registration. Herein, the group may indicate a set of devices previously assigned so as for a context to extend therebetween. The group may indicate a specific home, office, company, community, or the like. A set of all devices capable of performing the context extension method according to the present disclosure does not corresponds to the group herein, but a set of devices among all the devices, assigned separately or directly so as for a context to extend therebetween, may indicate the group. The transmission of the context information from the context information generation apparatus 20 to the context extension apparatus 10 may indicate transmitting the context information to a device which is not registered in the same group in which the context information generation apparatus 20 is registered.

The transmission of the context information from the context information generation apparatus 20 to the context extension apparatus 10 may indicate broadcasting the context information to a random device regardless of whether the random device is registered to a same user or group to which the context information generation apparatus 20 is registered. The transmission of the context information from the context information generation apparatus 20 to the context extension apparatus 10 may indicate broadcasting the context information to a nearby device regardless of whether the nearby device is registered to a same user or group to which the context information generation apparatus 20 is registered. The context extension apparatus 10 and the context information generation apparatus 20 may not be assigned or registered separately or directly so as for a context to extend therebetween except that the context extension apparatus 10 and the context information generation apparatus 20 can perform the context extension method according to the present disclosure. For example, while a certain user is having a meal at a restaurant with an own smartphone, a television provided in the restaurant may broadcast information about content being currently played, by using short-range communication, and the smartphone of the user may receive the broadcast information. In this case, the smartphone of the user, the television in the restaurant, and the information about the content being currently played may correspond to the context extension apparatus 10, the context information generation apparatus 20, and context information, respectively. Also, the smartphone of the user, which is the context extension apparatus 10, and the television, which is the context information generation apparatus 20, may not be assigned or registered in advance therebetween except that the smartphone of the user and the television can perform the context extension method according to the present disclosure.

The transmission of the context information to the context extension apparatus 10 may indicate transmitting the context information to a pre-assigned device. The transmission of the context information from the context information generation apparatus 20 to the context extension apparatus 10 may indicate transmitting the context information to a device existing nearby at present among devices registered to a same user or group to which the context information generation apparatus 20 is registered. The transmission of the context information from the context information generation apparatus 20 to the context extension apparatus 10 may indicate transmitting the context information to a device via another device. Herein, another device may indicate a simple stopover or a device for actively collecting and delivering context information. The device for collecting and delivering context information may deliver context information between devices existing nearby by using position information of the context information generation apparatus 20 and the context extension apparatus 10.

The context information generation apparatus 20 may automatically transmit context information without a command of a user. The context information generation apparatus 20 may transmit context information as the context information is generated. The context information generation apparatus 20 may transmit context information when a state change occurs. The context information generation apparatus 20 may transmit context information at a time point independently to a context information generation time point. The context information generation apparatus 20 may repetitively transmit context information. The context information generation apparatus 20 may periodically transmit context information. The context information generation apparatus 20 may transmit context information at a random time. The context information generation apparatus 20 may continuously transmit context information.

FIG. 4 is a schematic flowchart of an operating method of a context extension apparatus, according to an embodiment of the present disclosure. Referring to FIG. 4, the processor 12 of the context extension apparatus 10 may receive context information from the context information generation apparatus 20 in operation S41, determine a context extension action based on the received context information and a context extension trigger event in response to the occurrence of the context extension trigger event in operation S42, and allow the determined context extension action to be performed in operation S43.

As described above with reference to FIG. 3, the reception of the context information by the context extension apparatus 10 may indicate receiving, by the context extension apparatus 10, the context information transmitted from the context information generation apparatus 20 by assigning the context extension apparatus 10 as a destination, or receiving, by the context extension apparatus 10, the context information transmitted from the context information generation apparatus 20 to a random device without assigning a destination. The reception of the context information by the context extension apparatus 10 may indicate receiving the context information broadcast from the context information generation apparatus 20. The reception of the context information by the context extension apparatus 10 may indicate receiving the context information transmitted from devices existing nearby by using short-range communication. The reception of the context information from the context information generation apparatus 20 by the context extension apparatus 10 may indicate receiving the context information transmitted via another device. The context extension apparatus 10 may be or may not be registered to a same user or group to which the context information generation apparatus 20 is registered. The context extension apparatus 10 and the context information generation apparatus 20 may not be assigned or registered separately or directly so as for a context to extend therebetween. The context extension apparatus 10 may receive context information of a corresponding device from each of a plurality of context information generation apparatuses 20.

The context extension trigger event is, as an event of triggering a context extension action, an event occurring by a behavior of a user. The context extension trigger event may occur by an interaction between the user and one or more IoT devices. The context extension trigger event may indicate sensing a physical interaction between the user and an IoT device. The context extension trigger event may indicate sensing a gesture of the user by an IoT device.

For example, the context extension trigger event may indicate taking or putting a smartphone out or in a pocket, picking up a tablet computer put on a table or putting down a tablet computer held in a hand, locking or unlocking a smartphone, opening or closing a cover of a laptop computer, pushing an application switching button, checking time with a smart watch, turning on or off a television, switching a television to be silent, calling a smart speaker, making two devices close to each other, opening a door of a refrigerator, a microwave, a wardrobe, a vehicle, a house, or the like, sitting on a chair, or the like.

The context extension trigger event may be a set or a combination of a plurality of individual events. The context extension trigger event may be determined based on a state change inside a physical sensor included in a device, inside the device, or the like. When the context extension trigger event occurs, a state of a corresponding device may change, and thus, context information of the corresponding device may be generated according to the context extension trigger event.

The context extension trigger event may occur in the context extension apparatus 10 or another device. The context extension apparatus 10 receive information about the occurrence of a context extension trigger event from another device. Like receiving context information from the context information generation apparatus 20, the reception, by the context extension apparatus 10, of the information about the occurrence of the context extension trigger event from another device may indicate receiving the information transmitted from a device in which the context extension trigger event has occurred, by assigning the context extension apparatus 10 as a destination, or receiving the information transmitted from the device in which the context extension trigger event has occurred, without assigning a destination. The reception, by the context extension apparatus 10, of the information about the occurrence of the context extension trigger event may indicate receiving the information broadcast from a device in which the context extension trigger event has occurred. The reception, by the context extension apparatus 10, of the information about the occurrence of the context extension trigger event may indicate receiving the information transmitted from devices existing nearby by using short-range communication. The reception, by the context extension apparatus 10, of the information about the occurrence of the context extension trigger event from a device in which the context extension trigger event has occurred may include receiving the information transmitted via another device.

The device in which the context extension trigger event has occurred may be or may not be registered to a same user to which the context extension apparatus 10 or the context information generation apparatus 20 is registered. The device in which the context extension trigger event has occurred may be or may not be registered in the same group in which the context extension apparatus 10 or the context information generation apparatus 20 is registered. The device in which the context extension trigger event has occurred, the context extension apparatus 10, and the context information generation apparatus 20 may not be assigned or registered separately or directly so as for a context to extend therebetween.

The device in which the context extension trigger event has occurred may be the same as or difference from the context information generation apparatus 20. The context extension apparatus 10 may receive context information from a device other than the device in which the context extension trigger event has occurred. That is, the context extension apparatus 10 may receive context information from a first device, receive information about the occurrence of a context extension trigger event from a second device, and determine a context extension action based on the received context information and information.

The context extension trigger event may be an event according to a random behavior of the user or be one of pre-defined events. According to an embodiment, the context extension apparatus 10 may determine a context extension action based on context information for events according to all behaviors of the user. According to an embodiment, the context extension apparatus 10 may monitor whether any one of pre-defined context extension trigger events occurs. The context extension trigger event may be determined according to context information which the context extension apparatus 10 has at present. The context extension apparatus 10 may dynamically determine at least one context extension trigger event to be detected, according to received context information. The context extension trigger event may be determined according to context information which the context extension apparatus 10 has at present and a context extension action to be performed in association with the context information. The context extension apparatus 10 may dynamically determine at least one context extension trigger event to be detected, according to received context information and a context extension action to be performed in association with the received context information.

The context extension method according to the present disclosure may automatically perform an action suitable for a certain behavior or recommend the action to the user when the user takes the certain behavior, by using the context extension trigger event described above. The context extension method according to the present disclosure may more accurately determine an action suitable for an intention of the user by using not only simple context information but also a context extension trigger event which occurs in response to a behavior of the user.

The context extension action may be an action predicted or recommended/suggested for the user to take next according to context information and a context extension trigger event. The context extension action may be a set or a combination of a plurality of individual actions. For example, the context extension action may include executing a specific application, automatically filling in detailed items of a specific application, executing a specific application and automatically filling in detailed items of a corresponding application, or the like. The context extension apparatus 10 may determine a context extension action based on a relationship between respective pieces of context information received from a plurality of context information generation apparatuses 20. The context extension apparatus 10 may use artificial intelligence to determine a context extension action suitable for context information and a context extension trigger event. The context extension apparatus 10 may determine a context extension action based on an action list. The action list may be stored in a database and updated and managed using artificial intelligence, as described below. The user may add or remove a desired action to or from the action list in accordance with circumstances.

The context extension action does not include an action which directly occurs by a context extension trigger event. For example, when a context extension trigger event is pushing an application switching button by the user, displaying an application switching screen image cannot be a context extension action, but automatically switching to a specific application may be a context extension action. When a context extension trigger event is switching to a specific application by the user, executing a corresponding application cannot be a context extension action, but automatically filling in detailed items in the corresponding application may be a context extension action.

According to an embodiment, the context extension apparatus 10 may determine input contents for a specific application based on context information and a context extension trigger event, and a context extension action may be inputting the determined input contents into a corresponding application.

According to an embodiment, the context extension apparatus 10 may determine a context extension action based on a time point related to context information and a time point related to a context extension trigger event. Herein, the time point related to the context information may be a time point at which the context information was received, a time point at which the context information was generated, a time point at which a state related to the context information occurred, or the like. The time point related to the context extension trigger event may be a time point at which the context extension trigger event was received, a time point at which the context extension trigger event occurred, a time point at which an operation related to the context extension trigger event was performed, or the like. The context extension apparatus 10 may determine a context extension action based on a time difference between a time point related to context information and a time point related to a context extension trigger event. For example, the context extension apparatus 10 may determine that context information is related to a context extension trigger event when a time difference between an occurrence time point of a state occurred at the last among states related to the context information and an occurrence time point of an initially occurred operation among operations related to the context extension trigger event is within a predetermined value, and determine a context extension action based on the context information and the context extension trigger event. As another example, the context extension apparatus 10 may determine a context extension action according to a magnitude of a time difference between a time point at which context information occurred and a time point at which a context extension trigger event occurred.

The context extension apparatus 10 may allow the determined context extension action to be automatically performed. The context extension apparatus 10 may allow the determined context extension action to be performed without a clear instruction of the user. The context extension apparatus 10 may allow the determined context extension action to be performed unless a clear rejection behavior of the user exists. For example, the context extension apparatus 10 may allow the context extension action to be performed when the user does not input a rejection within a predetermined time after the determined context extension action is suggested to the user. The context extension apparatus 10 may allow the determined context extension action to be performed according to selection of the user. The context extension apparatus 10 may allow the user check whether the context extension action is performed after the context extension action is suggested. The context extension apparatus 10 may suggest a plurality of context extension actions and allow an action selected by the user among the plurality of context extension actions to be performed

The allowing, by the context extension apparatus 10, of the context extension action to be performed may indicate that the context extension apparatus 10 performs the context extension action. The allowing, by the context extension apparatus 10, of the context extension action to be performed may indicate that another device performs the context extension action. The context extension apparatus 10 may allow a device in which a context extension trigger event has occurred to perform the context extension action. The context extension apparatus 10 may allow a device other than the device in which the context extension trigger event has occurred to perform the context extension action. The context extension apparatus 10 may generate context extension information including information about a context extension action, determine a device by which the context extension action is to be performed, and transmit the context extension information to the determined device such that the context extension action is performed. The context extension apparatus 10 may determine the device by which the context extension action is to be performed, from the context information generation apparatus 20, the device in which the context extension trigger event has occurred, or a device existing nearby at least one of the context information generation apparatus 20 and the device in which the context extension trigger event has occurred.

The allowing, by the context extension apparatus 10, of the context extension action to be performed may indicate that a specific application performs the context extension action. The context extension apparatus 10 may determine an application by which the context extension action is to be performed and deliver context extension information to the determined application such that the context extension action is performed. The allowing, by the context extension apparatus 10, of the context extension action to be performed may indicate that a specific framework or a specific service performs the context extension action. The context extension apparatus 10 may determine a framework or service by which the context extension action is to be performed and deliver context extension information to the determined framework or service such that the context extension action is performed. The context extension information may be used by being delivered to a specific IoT device, a specific frame work, a specific service, or a specific application.

The device by which the context extension action is to be performed may be or may not be registered to a same user to which the context extension apparatus 10, the context information generation apparatus 20, or a device to which a context extension trigger event occurred is registered. The device by which the context extension action is to be performed may be or may not be registered in the same group in which the context extension apparatus 10, the context information generation apparatus 20, or the device in which the context extension trigger event occurred is registered. The device by which the context extension action is to be performed, the context extension apparatus 10, the context information generation apparatus 20, or the device in which the context extension trigger event occurred may not be assigned or registered separately or directly so as for a context to extend therebetween.

The context extension apparatus 10 may determine a plurality of devices by which the context extension action is to be performed and transmit context extension information to at least one of the determined plurality of devices such that the context extension action is performed by the plurality of devices in a linked manner. The context extension apparatus 10 may transmit, to the device by which the context extension action is to be performed, information about another device by which the context extension action is to be performed in a linked manner One of the plurality of devices by which the context extension action is to be performed may be the context extension apparatus 10.

The context extension apparatus 10 may determine the context extension action based on use history information. The use history information may be information about a past use history of a specific IoT device. The use history information may be information about a past use history of an IoT device for a specific user or a specific group. The use history information may be information about a past use history of an IoT device regardless of a specific user or a specific group. The use history information may include a browsing history or an application use history. The browsing history may include a search history, cookies, a cache file, and the like. The application use history may include an application use pattern, an application use time, and the like. The use history information may be a use history of the context extension apparatus 10, the context information generation apparatus 20, or the device in which the context extension trigger event occurred. The context extension apparatus 10 may receive the use history information from another device. The context extension apparatus 10 may receive the use history information from the context information generation apparatus 20 or the device in which the context extension trigger event occurred. The context extension apparatus 10 may receive the use history information in various communication schemes and receive the use history information via another device. The context extension apparatus 10 may receive use history information of a device other than a context information generation apparatus, and determine a context extension action based on a relationship between context information and the use history information That is, the context extension apparatus 10 may receive context information of a first device, receive use history information of a second device, and determine a context extension action based on a relationship between the context information of the first device and the use history information of the second device.

The use history information may be related to or regardless of a specific user or a specific group. For example, the context extension apparatus 10 may determine a context extension action based on use history information of the context information generation apparatus 20 registered to a same user to which the device in which the context extension trigger event occurred is registered. The context extension apparatus 10 may refer to use history information of a user of the device in which the context extension trigger event occurred among pieces of use history information of a plurality of users of the context information generation apparatus 20. The context extension apparatus 10 may refer to use history information of a user who made the context extension trigger event occur among pieces of use history information of a plurality of users of the context information generation apparatus 20.

The context extension apparatus 10 may determine a context extension action with reference to a database. The database may be included in the context extension apparatus 10 or a separate database device. The database may store therein information about context information, context extension trigger events, use history information, context extension actions, an action list, and the like. The database may store therein a relationship between at least one of context information, use history information, and context extension trigger events and context extension actions.

According to an embodiment, the context extension apparatus 10 may determine a context extension action based on matching information among the context information, the context extension trigger events, and the context extension actions stored in the database. According to an embodiment, the context extension apparatus 10 may determine a context extension action based on matching information among the context information, the context extension trigger events, the use history information, and the context extension actions stored in the database. The context extension apparatus 10 may determine a context extension action based on data related to a specific user or a specific group among data stored in the database.

According to an embodiment, the context extension apparatus 10 may update the database based on context information received from the context information generation apparatus 20, an occurred context extension trigger event, and an actually performed action. According to an embodiment, the context extension apparatus 10 may update the database based on context information received from the context information generation apparatus 20, an occurred context extension trigger event, use history information, and an actually performed action. The context extension apparatus 10 may update matching information between the context information and the context extension actions stored in the database. The context extension apparatus 10 may update matching information among the context information, the context extension trigger events, and the context extension actions stored in the database. The context extension apparatus 10 may update matching information among the context information, the context extension trigger events, the use history information, and the context extension actions stored in the database.

Herein, the actually performed action may be or may not be suggested by the context extension apparatus 10. The actually performed action may include an action performed by confirmation or selection of the user or performed because the user did not reject, among actions suggested by the context extension apparatus 10. The actually performed action may include an action consecutively performed after performing an action suggested by the context extension apparatus 10. The actually performed action may include an action performed within a predetermined time after performing an action suggested by the context extension apparatus 10.

The context extension apparatus 10 determine whether the actually performed action is related to context information and a context extension trigger event. According to an embodiment, the context extension apparatus 10 may determine whether an action is related to context information and a context extension trigger event, based on a relationship between a time point related to the context information or a time point related to the context extension trigger event and a performing time point of the action. The actually performed action may include an action performed within a predetermined time from an occurrence time point of at least one of context information received from the context information generation apparatus 20 or an occurred context extension trigger event. The context extension apparatus 10 may update the database through artificial intelligence and machine learning.

The context extension method according to the present disclosure is not dependent on a device, a platform, or an application. That is, according to the context extension method according to the present disclosure, a context may extend between difference devices, difference platforms, or different applications. Therefore, an application related to context information may differ from an application related to a context extension action. The application related to the context information may be an application which has caused the context information to occur. The application related to the context information may be an application in which the context information has occurred. The application related to the context extension action may be an application by which the context extension action is to be performed. The application related to the context extension action may be an application in which the context extension action is to be performed. The different applications may not be the same or similar applications. The non-similar applications may indicate applications which are not supposed to be executed in a linked manner or applications which are not designed to be executed in a direct link therebetween. Therefore, according to the present disclosure, a context may extend between applications which could not be executed in a linked manner.

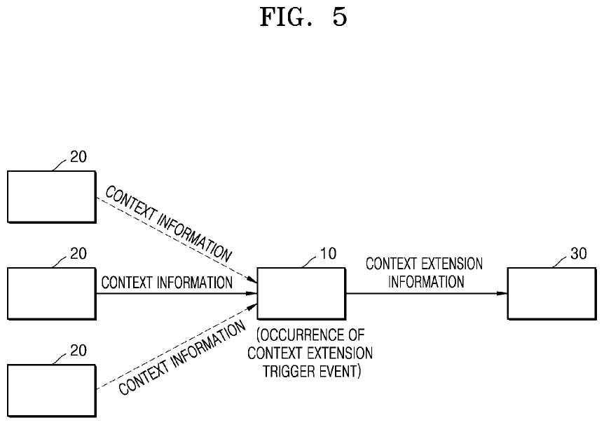

FIG. 5 illustrates an operation of a context extension apparatus, according to an embodiment of the present disclosure. FIG. 5 illustrates a case where a context extension trigger event has occurred in the context extension apparatus 10. The context extension apparatus 10 may receive context information from one or more context information generation apparatuses 20, determine a context extension action based on the received context information and a context extension trigger event in response to an occurrence of the context extension trigger event, and allow a context extension action performing apparatus 30 to perform the determined context extension action. Context information of the context extension apparatus 10 or context information of the context extension action performing apparatus 30 may be used. The context extension apparatus 10 may receive the context information from the context information generation apparatus 20 via another device.

Herein, two or more of the context extension apparatus 10, the context information generation apparatus 20, and the context extension action performing apparatus 30 may be same. When two of the context extension apparatus 10, the context information generation apparatus 20, and the context extension action performing apparatus 30 are same, data transmission between the two apparatuses may be in-apparatus data transmission or in-processor data transmission. For example, when the context extension apparatus 10 is the same as the context information generation apparatus 20, the processor 12 may be the same as the processor 22, and context information transmission from the context information generation apparatus 20 to the context extension apparatus 10 may be in-processor data transmission. In this case, the context extension apparatus 10 and the context information generation apparatus 20 may be different modules in one device. When the context extension apparatus 10 is the same as the context extension action performing apparatus 30, the context extension apparatus 10 may autonomously perform the determined context extension action.

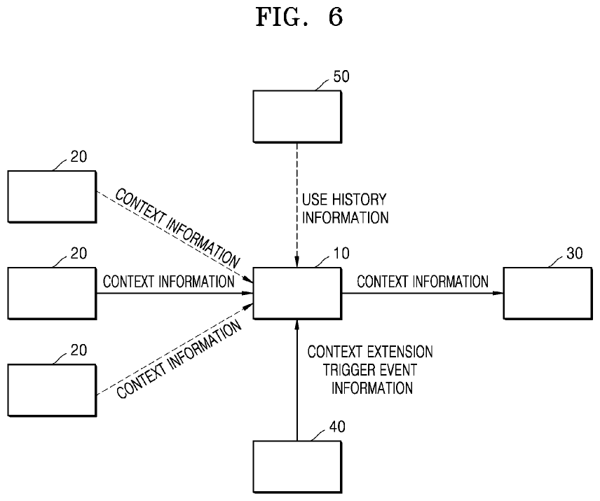

FIG. 6 illustrates an operation of a context extension system, according to an embodiment of the present disclosure. FIG. 6 illustrates a case where a context extension trigger event has occurred in an apparatus 40 other than the context extension apparatus 10. The context extension apparatus 10 may receive context information from one or more context information generation apparatuses 20, receive information about a context extension trigger event from the context extension trigger event generation apparatus 40, determine a context extension action based on the received context information and the information about an occurred context extension trigger event, and allow the context extension action performing apparatus 30 to perform the determined context extension action. The context extension apparatus 10 may determine whether the context information generation apparatuses 20 and the context extension trigger event generation apparatus 40 are located in a near distance from the context extension apparatus 10, based on position information of the context information generation apparatuses 20 and the context extension trigger event generation apparatus 40. The context extension apparatus 10 may use context information of the context extension apparatus 10, context information of the context extension action performing apparatus 30, or the context extension trigger event generation apparatus 40.

The context extension apparatus 10 may receive the context information or the information about the context extension trigger event via another device. The context extension apparatus 10 may receive the context information from the context information generation apparatuses 20 via the context extension trigger event generation apparatus 40. That is, the context extension trigger event generation apparatus 40 may receive context information from at least one of the context information generation apparatuses 20 and transmit the received context information together with the information about the context extension trigger event. The context extension apparatus 10 may receive information about context extension trigger events from a plurality of context extension trigger event generation apparatuses 40 and determine a context extension action based on the received information about the context extension trigger events. The context extension apparatus 10 may receive user histories from one or more use history generation apparatuses 50 and determine a context extension action based on the received user histories.

Two or more of the context extension apparatus 10, the context information generation apparatus 20, the context extension action performing apparatus 30, the context extension trigger event generation apparatus 40, and the use history generation apparatus 50 may be same. For example, the context extension action performing apparatus 30 may be the same as the context extension trigger event generation apparatus 40. When the context extension apparatus 10 is the same as the context extension trigger event generation apparatus 40, this indicates the embodiment of FIG. 5.

One IoT device may be the context extension apparatus 10 and be simultaneously the context information generation apparatus 20 in a relationship with another IoT device. That is, an IoT device may receive context information from other IoT device and determine context extension, and may transmit context information of the IoT device to the other IoT device such that the other IoT device determines the context extension. One IoT device may also be the context extension action performing apparatus 30, the context extension trigger event generation apparatus 40, or the use history generation apparatus 50 in a relationship with another IoT device. In other words, according to the present disclosure, all IoT devices in a context extension ecosystem may perform context extension while giving and taking information about the context extension therebetween.

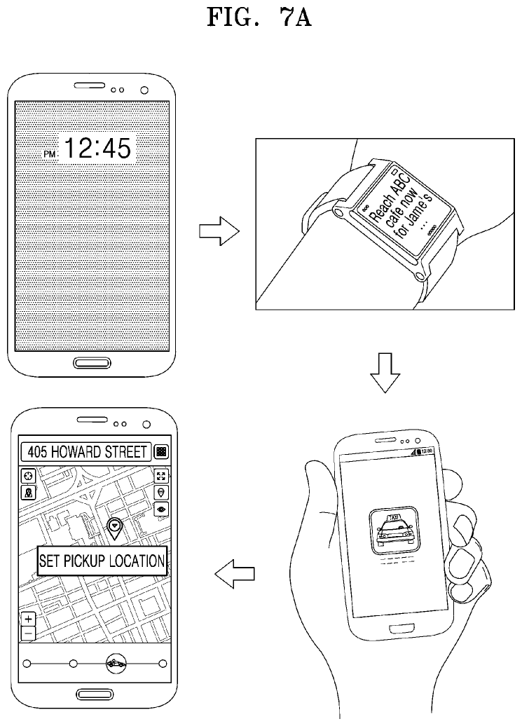

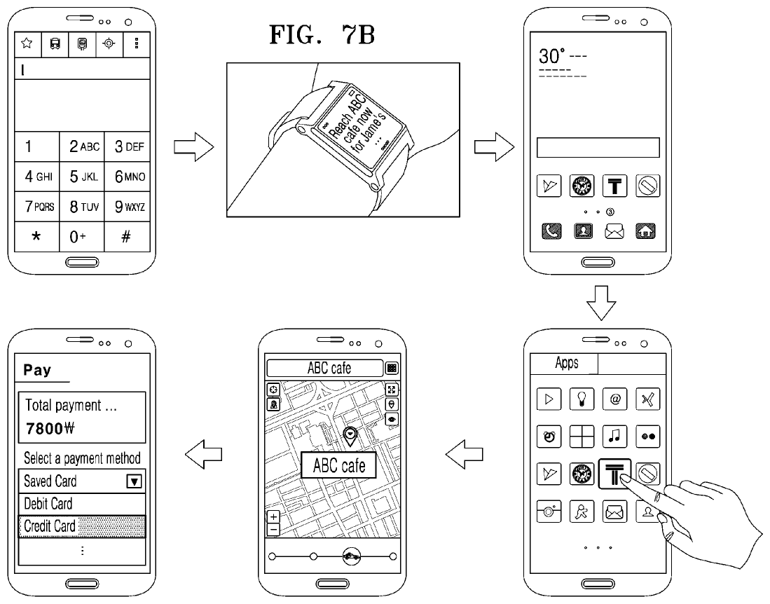

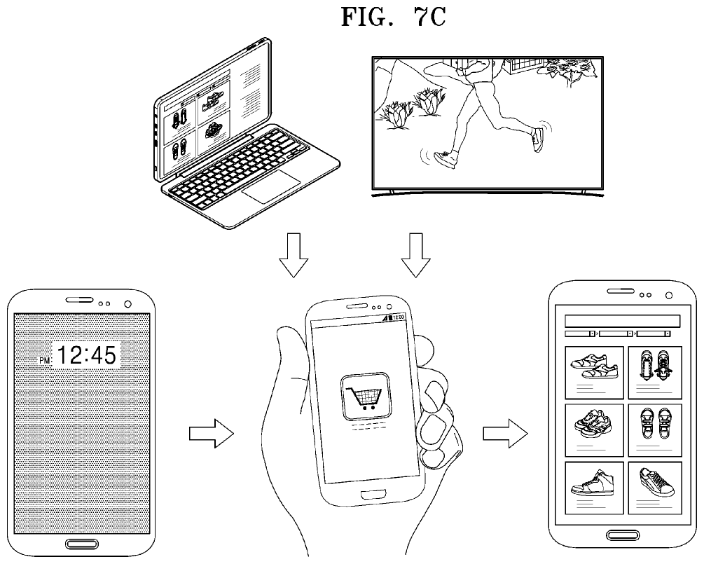

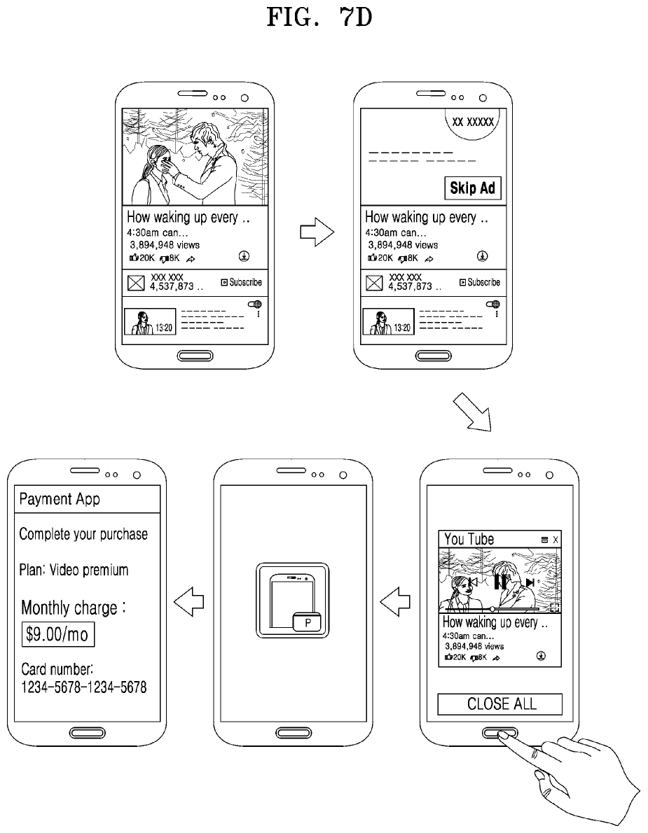

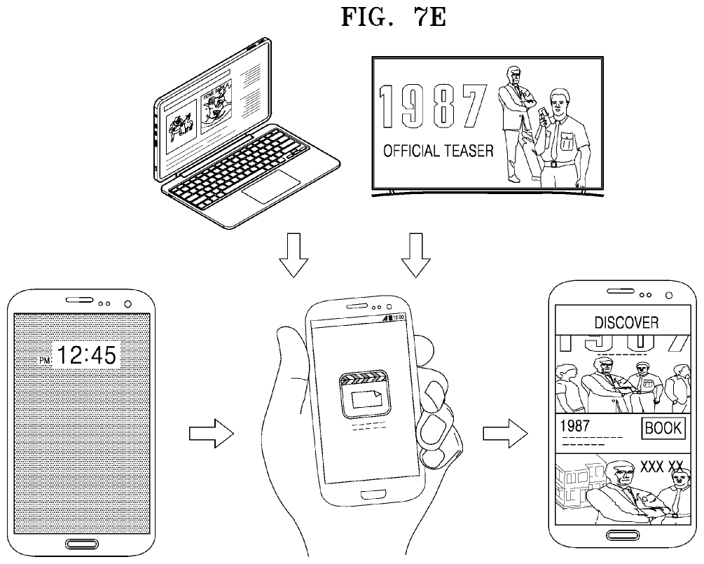

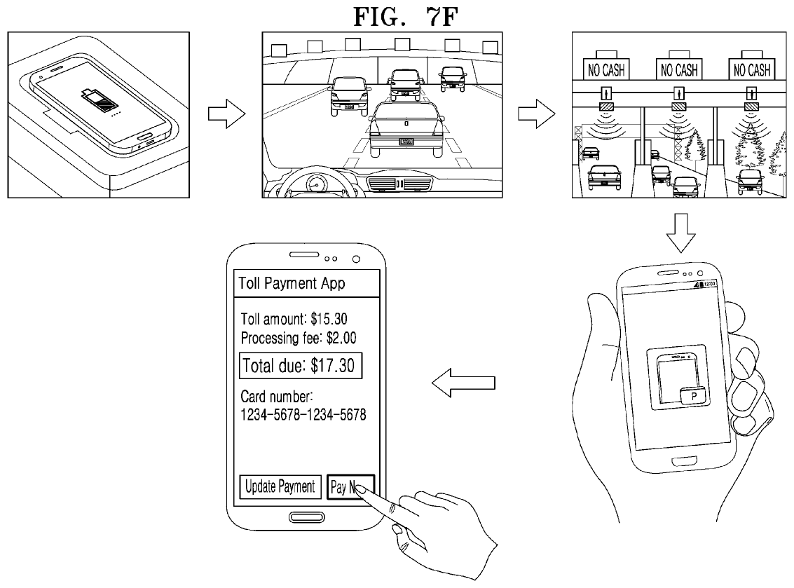

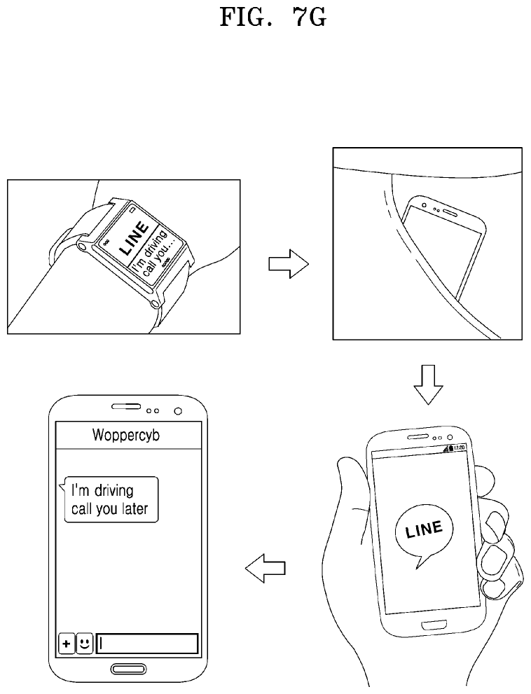

From now on, various scenarios according to the present disclosure will be described with reference to FIGS. 7A to 7G.

FIG. 7A illustrates a taxi reservation scenario according to an embodiment of the present disclosure. Referring to FIG. 7A, when a user wears a smart watch, and a text message related to movement such as “come to the ABC café right now for a birthday party of James” is received to the smart watch, a taxi application may be automatically executed in a smartphone when the user picks up the smartphone in an idle state.

Herein, the smartphone may be the context extension apparatus 10, and the smart watch may be the context information generation apparatus 20. When the text message is received, the smart watch may notify the user of the reception of the text message, generate context information indicating that a notification related to the text message is popped up, and transmit the generated context information to the smartphone. The smartphone may receive the context information from the smart watch, and determine a context extension action based on the context information and a context extension trigger event in response to the occurrence of the context extension trigger event.

The smartphone may be the context extension trigger event generation apparatus 40. The context extension trigger event may indicate that the user picks up the smartphone put on a table or takes out the smartphone from a pocket. The smartphone may detect that the user picks up the smartphone or takes out the smartphone from the inside of the pocket, by using an acceleration sensor, a proximity sensor, or the like. The smartphone may use, as context information of the smartphone, the fact that the smartphone is put on a table or is inside a pocket. That is, the smartphone may be the context information generation apparatus 20. The smartphone may determine a context extension action based on the contents of the notification popped up on the smart watch and a behavior of the user of picking up the smartphone.

The smartphone may be the context extension action performing apparatus 30. The determined context extension action may indicate executing the taxi application, or executing the taxi application and inputting “ABC café” as a destination. The smartphone may execute the taxi application when the user picks up the smartphone within a predetermined time, e.g., 30 seconds, after the text message is displayed on a screen of the smart watch.

Herein, the smartphone may be the context extension apparatus 10 and be simultaneously the context extension trigger event generation apparatus 40 and the context extension action performing apparatus 30. The context extension apparatus 10 may be a separate device other than the smartphone.

When the user is using the smartphone, the execution of the taxi application by the user may be a context extension trigger event. This scenario will be described with reference to FIG. 7B.

FIG. 7B illustrates a taxi reservation scenario according to an embodiment of the present disclosure. Referring to FIG. 7B, if the user is already using the smartphone when the text message “come to the ABC café right now for a birthday party of James” is received to the smart watch of the user, when the user executes the taxi application, the smartphone may automatically input “ABC café” as a destination of the taxi application. In this case, the execution of the taxi application by the user's input is a context extension trigger event. The smartphone may use, as context information of the smartphone, a state in which the user is currently using the smartphone.

Alternatively, even though the user is not using the smartphone when the text message is received, when the user picks up the smartphone after a predetermined time, e.g., 30 seconds, the context extension apparatus 10 may not automatically execute the taxi application. In this case, when the user executes the taxi application after picking up the smartphone, the execution of the taxi application is recognized as a context extension trigger event for inputting “ABC café” as a destination, and “ABC café” may be automatically input as a destination of the taxi application. When the user executes the taxi application within a predetermined time, e.g., 10 minutes, after displaying the text message on the screen of the smart watch, the smartphone may input “ABC café” as a destination. In addition, the smartphone may automatically open a taxi fare payment screen image.

FIG. 7C illustrates a sneakers purchase scenario according to an embodiment of the present disclosure. Referring to FIG. 7C, when a user has a recent search history related to sneakers purchase by using a laptop computer, and a sneakers advertisement of a specific brand is played on a television, if the user picks up a smartphone put on a table, a shopping application is automatically executed, and a search word related to the sneakers of the brand being advertised in the television may be automatically input.

Herein, the smartphone may be the context extension apparatus 10, and at least one of the laptop computer and the television may be the context information generation apparatus 20. The laptop computer may be the use history generation apparatus 50 The laptop computer may generate use history information indicating that the user has recently searched about sneakers purchase and transmit the generated use history information to the smartphone. In this case, the laptop computer and the smartphone may be registered to a same user. The user may log in a browser on the laptop computer and perform a search by using the same account as used in the smartphone. The television may belong to the user or may be a random television existing nearby. For example, the television may be provided to a restaurant, a school, a company, a subway, an airport, or the like. The television may transmit, to all devices existing nearby, context information indicating that content being currently played is a sneakers advertisement of a specific brand, through Bluetooth, ultrasound communication, invisible code of OWC, which is displayed on a screen, or the like. The smartphone may receive the context information from the television.

A context extension trigger event may indicate that the user picks up the smartphone put on a table. The smartphone may use, as context information of the smartphone, the fact that the smartphone is put on the table at present. The smartphone may determine a context extension action based on the user's search history received from the laptop computer, the content being currently played, which is received from the television, and a behavior of the user of picking up the smartphone. The determined context extension action may be executing the shopping application, or executing the shopping application and inputting, in a search window, a search word related to the user's search history and the advertisement being played on the television. The smartphone may execute the shopping application when the user picks up the smartphone within a predetermined time after the sneakers advertisement started on the television.

The context extension trigger event may indicate that the user executes the shopping application. The smartphone may determine, as a context extension action, inputting, in the search window, the search word related to the user's search history and the advertisement being played on the television, based on the user's search history received from the laptop computer, the content being currently played, which is received from the nearby television, and a behavior of the user of executing the shopping application.

Herein, the smartphone may be the context extension apparatus 10 and be simultaneously the context extension trigger event generation apparatus 40 and the context extension action performing apparatus 30. The context extension apparatus 10 may be a separate device other than the smartphone.

FIG. 7D illustrates a video product payment scenario according to an embodiment of the present disclosure. Referring to FIG. 7D, an interstitial advertisement may be executed while a user is watching a video by using a video application. The user pushes an application switching button as soon as the interstitial advertisement is executed. A smartphone may determine that the user wants to perform a payment so as not to play the interstitial advertisement during the video application, and execute a payment-related application. The smartphone may display a payment screen image through the payment-related application and automatically fill, in the payment screen image, products and payment means information usually used by the user.

Herein, the smartphone may be the context extension apparatus 10 and be simultaneously the context information generation apparatus 20. The smartphone may use, as context information of the smartphone, the fact that an interstitial advertisement is being played in a specific video application. The smartphone may recognize, as a context extension trigger event, the fact that the user has pushed the application switching button.

The smartphone may determine a context extension action based on the information indicating that the interstitial advertisement is being played in the video application and a behavior that the user pushes the application switching button. The smartphone may be the use history generation apparatus 50. The smartphone may use, as use history information of the smartphone, the fact that the user has been regularly using the video application on pay per view. The smartphone may use, as use history information of the smartphone, the products and the payment means information usually used by the user. The smartphone may be the context extension action performing apparatus 30. The determined context extension action may be executing the payment-related application, or executing the payment-related application and inputting a product to be paid and payment means information in a search window. The smartphone may automatically execute the payment-related application when the user pushes the application switching button in the middle of playing the interstitial advertisement or within a predetermined time after starting the interstitial advertisement. The context extension apparatus 10 may be a separate device other than the smartphone.

FIG. 7E illustrates a movie purchase scenario according to an embodiment of the present disclosure. Referring to FIG. 7E, when a user has recently read a review of a specific film through a laptop computer, and a trailer of the specific film is being played on a nearby television, if the user unlocks a locked smartphone, a shopping application may be automatically executed, and a search word related to the film being played on the television may be automatically inputted. The smartphone may suggest the user to select execution of a video on demand (VOD) application or a movie ticket purchase application.

FIG. 7F illustrates a toll payment scenario according to an embodiment of the present disclosure. Referring to FIG. 7F, when a user carrying a smartphone approaches a tollgate on a vehicle, if the user picks up the smartphone put on a seat, a payment application may be automatically executed, and detailed items related to a toll payment may be automatically inputted.

Herein, the smartphone may be the context extension apparatus 10, and the tollgate may be the context information generation apparatus 20. The tollgate may be an IoT device which is not registered in a specific user. That is, the tollgate may be a device which is not registered to a same user to which the smartphone is registered. The tollgate may broadcast information about a toll as context information to nearby IoT devices by using short-range communication or the like. The context information generation apparatus 20 provided on each lane of the tollgate may transmit the context information only to vehicles traveling on a corresponding lane.

The smartphone may be the context extension trigger event generation apparatus 40. Approaching of the smartphone to the tollgate according to the movement of the user carrying the smartphone, picking-up of the smartphone by the user, or a combination thereof may be a context extension trigger event. The smartphone may be the context information generation apparatus 20. The smartphone may use, as context information of the smartphone, the fact that the smartphone is moving at a high speed. The smartphone may be the use history generation apparatus 50. The smartphone may use, as use history information of the smartphone, a past payment history of the user, payment means information of the user, vehicle information of the user, or the like. The smartphone may determine a context extension action based on information about a toll received from the tollgate, the fact that the smartphone is moving at a high speed, a payment history of the user, and the like.

The smartphone may be the context extension action performing apparatus 30. The determine context extension action may be executing a payment application, or executing the payment application and automatically inputting detailed items related to a toll payment. The context extension apparatus 10 may be a separate device other than the smartphone.

FIG. 7G illustrates a chat window opening scenario according to an embodiment of the present disclosure. Referring to FIG. 7G, when a user wears a smart watch, and a message of a specific messenger (e.g., Line, KakaoTalk, or Facebook) is received to the smart watch, if the user takes out a smartphone from a pocket, the messenger may be automatically executed in the smartphone, and a chat window corresponding to the received message may be automatically opened.

Herein, the smartphone may be the context extension apparatus 10, and the smart watch may be the context information generation apparatus 20. The smart watch may notify the user of reception of a message when the message is received, generate context information indicating arrival of a specific message of a specific messenger, and transmit the generated context information to the smartphone. The smartphone may receive the context information from the smart watch, and may determine a context extension action based on the context information and a context extension trigger event when the context extension trigger event occurs.

The smartphone may be the context extension trigger event generation apparatus 40. The context extension trigger event may indicate that the user takes out the smartphone from a pocket. The smartphone may determine a context extension action based on the message received to the smart watch and a behavior that the user takes out the smartphone. The smartphone may be the context extension action performing apparatus 30. The determined context extension action may be executing a corresponding messenger application, or executing the messenger application and opening a chat window corresponding to a corresponding message.

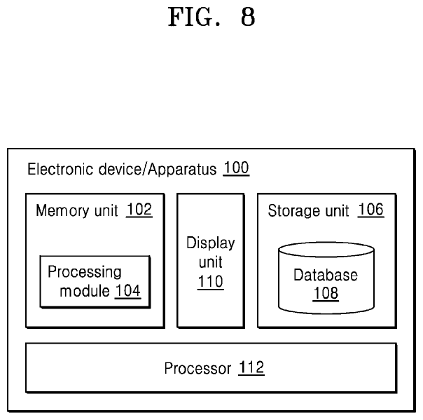

Hereinafter, embodiments of the present disclosure will be described with reference to FIGS. 8 to 12. Context information of an IoT device may include a characteristic of the IoT device, state information of the IoT device, context data related to the IoT device, or device meta-data. A context extension trigger event may include interaction data related to the IoT device or user trigger data. A context extension action may include a context aware interaction. Context extension information may include context extension data, context continuity intentions, or context intention data.

FIG. 8 illustrates a block diagram of an apparatus 100 for managing context aware interaction between Internet of Things (IoT) device(s) in an IoT environment, according to embodiments as disclosed herein;

The apparatus 100 includes a memory unit 102, a storage unit 106, a display unit 110, and a processor 112. Further, the apparatus 100 may include a processing module 104 residing in the memory unit 102. When the machine readable instructions are executed, the processing module 104 causes the apparatus 100 to process the data in a computing environment. Further, the apparatus 100 can also be referred herein to as an electronic device 100 and the apparatus 100 can act as a server. Examples of the apparatus 100/electronic device 100 can be, but not limited to, a mobile phone, a smart phone, a tablet, a handheld device, a phablet, a laptop, a computer, a wearable computing device, a server, an Internet of Things (IoT) device, an IoT hub, and so on. The apparatus 100 may comprise other components such as input/output interface(s), communication interface(s) and so on (not shown). The apparatus 100 may comprise a user application interface (not shown) and an application management framework (not shown) and an application framework (not shown) for managing the context aware interaction between Internet of Things (IoT) device(s) in an IoT environment. The application framework can be a software library that provides a fundamental structure to support the development of applications for a specific environment. The application framework may also be used in developing graphical user interface (GUI) and web-based applications. Further, the application management framework may be responsible for the management and maintenance of the application and definition of the data structures used in databases and data files.

In an embodiment herein, the methods herein may be implemented using the apparatus 100. The embodiments herein may perform specified manipulations of data or information in response to a command or a set of commands provided by a user. In an embodiment herein, the methods herein may be implemented using apparatus 100 such as a server (not shown). The server may be implemented using apparatus 100. The apparatus 100 can operate as a standalone device or as a connected (e.g., networked) device that connects to other computer systems. In a networked deployment, the apparatus 100 may operate as the server or client in a server-client network environment, or as a peer device in a peer-to-peer (or distributed) network environment. Further, while only a single computer system is illustrated, a plurality of computing systems may operate to jointly execute instructions to perform any one or more of the methods discussed herein.

In an example, the apparatus 100 can be the Internet of Things (IoT) device such as an appliance, a sensor, the electronic device and so on, that has a communication interface and can transmit information to one or more other devices over a wired or wireless connection. The IoT device may have a passive communication interface, such as a quick response (QR) code, a radio-frequency identification (RFID) tag, an NFC tag, or the like, or an active communication interface, such as a modem, a transceiver, a transmitter-receiver, or the like. The IoT device can have a set of properties/attributes such as a device state or status. For example, the device status can be at least one of, whether the IoT device is switched on or switched off, open or closed, idle or active, available for task execution or busy, and so on, a cooling or heating function, an environmental monitoring or recording function, a light-emitting function, a sound emitting function and so on.

Examples of IoT devices may include at least one of, but not limited to, a refrigerator, a heater, a toaster, an oven, a microwave, a freezer, a dishwasher, a hand tool, a clothes washer, a clothes dryer, a furnace, an air conditioner, a thermostat, a television, a light fixture, a vacuum cleaner, a sprinkler, an electricity meter, a gas meter, a door, a vehicle, a cell phone, a smart phone, a desktop computer, a laptop computer, a tablet, a personal digital assistants (PDAs), a wearable computing device, and so on.

Furthermore, the apparatus may include a storage unit 106 and a database 108 to store the required data. The apparatus 100 may occasionally connect to the server (not shown) via a communication network (not shown). The communication network may be a wired (such as a local area network, Ethernet, and so on) or a wireless communication network (such as Wi-Fi, Bluetooth, and so on). The apparatus 100 may also retrieve the data from the external databases (not shown) based on the requirement and store the retrieved data in the local database 108 associated with the apparatus 100. The apparatus 100 can extract data from the remote database (not shown) and can launch the context aware interactions, for example, in response to a query or command received by the apparatus 100 or remote server (not shown).

In an embodiment, the methods herein may be implemented partly using a client device (not shown) and partly using the server. In an embodiment herein, the client device can be the electronic device 100 or apparatus 100. In an embodiment herein, the server can be a remote server or cloud server, wherein the client device and the server are communicatively coupled to establish a communication session. The methods herein can be performed in a sequential manner by the combination of the client device and the server. In an embodiment, the apparatus 100 may transmit the data to the server and the server may process the data. Further, the server may transmit back the context aware interaction to be executed by the apparatus 100 or another IoT device.

In an embodiment, the apparatus 100 is configured to obtain properties of at least one IoT device communicatively connected via a communication network, wherein the properties of at least one IoT device comprises at least one of a status, a content data, a context metadata, a browsing historical data, a search historical data, a usage data, and a device metadata. In an embodiment, the apparatus 100 is configured to analyze the obtained context metadata associated with the at least one device, based on the obtained properties of the at least one IoT device. The properties of at least one IoT device may be periodically transmitted by the respective IoT device to at least one of a respective application of the IoT device resided in another/master IoT device, an Original Equipment Manufacturer (OEM) application resided in another/master IoT device, a IoT/network hub, a cloud, via a communication network such as a Zigbee, a Bluetooth Low Energy (BLE), a Wi-Fi, and so on. The received properties from the IoT devices may be stored in the IoT/network hub, the cloud, the IoT device, and so on. In an embodiment, the apparatus 100 is configured to determine an interaction data associated with at least one IoT device based on the analyzed context metadata, wherein the interaction data comprises at least one of a user interaction data with the at least one second device, a user behavioral data and a user gesture data. The interaction data includes a periodic interaction data with the IoT device, an interaction for particular event, and so on, may be stored in the master/another IoT device. In an example, the interaction data includes, a moving pattern of the wearable computing device or IoT device, a gesture towards the IoT device, the user picking the smart phone from a pocket for a particular notification, and so on, may be shared with the cloud after storing in the IoT/network hub or master/another IoT device. In an example, if the user received a message along with the web link on the wearable computing device, to watch a video. Based on the received message the user picked smart phone from the pocket, then the smart phone may be configured to play the video received via the message. In an embodiment, the apparatus 100 is configured to output a context extension data to perform context aware interaction, by identifying at least one relevant IoT device to transmit the context extension data, based on analyzing at least one of the properties, the context metadata and the interaction data, wherein outputting comprises at least one of an executing application, executing a context aware interaction. For example, the apparatus 100 is configured to extract destination and time from a received message and push an action to the extended application or continuity application based on determined destination and time. The operation/action or event may be tagged to the extracted context data.

In an embodiment, the apparatus 100 is configured to identify periodically, a user trigger data corresponding to at least one of a user interaction and a user gesture, associated with the particular action and particular application. In an embodiment, the apparatus 100 is configured to analyze the obtained usage data, a current state information of the at least one IoT device, the context metadata of the at least one IoT device. In an embodiment, the apparatus 100 is configured to assimilate the analyzed usage data, the current state information of the at least one IoT device, the context metadata, with pre-determined data stored in a database 108. In an embodiment, the apparatus 100 is configured to determine the context data and context extension data based on the assimilating the analyzed data.

In an embodiment, the apparatus 100 is configured to assimilate the obtained context metadata with pre-determined data stored in the database 108. In an embodiment, assimilating comprises comparing the previously obtained properties with the currently obtained properties by sequential time-stepping process. The assimilation of the context metadata may include aggregation of data. In an example, the aggregated data may include time, place, event, action, suggestion, work, emotion, and so on. An intention of the context metadata may be created based on the aggregating the data. For example, the IoT refrigerator may send notification to the smart phone to buy vegetables immediately or may send notification as the stock of vegetables are consumable for two more days. Further, the smart phone will open a preferred application filled with list of vegetables if the user is in leisure time or at home or the smart phone will set a reminder to buy vegetables or pre-fill the list of vegetables in the application to open the application during the reminder time. In an embodiment, the apparatus 100 is configured to map a context intent data corresponding to the context metadata, wherein the context intent data comprises predicting the context aware interaction to be executed by at least one IoT device, based on mapping the context intent data with the context metadata. In an embodiment, the apparatus 100 is configured to generate the context aware interaction to be executed by at least one IoT device, based on mapping the context intent data corresponding to the context metadata. In an embodiment, the apparatus 100 is configured to output the context aware interaction associated with the context intent data. In an embodiment, the apparatus 100 is configured to receive an input from a first user device to a second user device in the IoT environment, wherein the input is received by the second user device via a wireless communication interface. In an embodiment, the apparatus 100 is configured to determine the content data and the context extension data associated with the first user device, based on the received input. In an embodiment, the apparatus 100 is configured to output the content data and the context extension data to the second user device, based on the determined content data and the context extension data.

In an embodiment, the status of the at least one device comprises a current state, a notifications, a text message, and a duration of idle state of the at least one device. In an embodiment, the content data, the context metadata and the device metadata comprises at least one of a context data, a media data, and an advertisement data; wherein the usage data comprises, duration of usage of an application, a usage pattern of the application. In an embodiment, the user behavioral data comprises at least one of an accessing the application, a search data, a subsequent application usage, and a substitute application usage. In an embodiment, the user trigger data comprises the user interaction for a particular event corresponding to at least one of the notification, the text message, the commercial advertisement, a phone call, a ecommerce shopping, a bill payment, a cab booking, a holiday booking and a movie booking. In an embodiment, outputting comprises causing the second device to resume the context aware interaction and pre-fill the required details.

The diagram of FIG. 8 illustrates functional components of the computer implemented system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

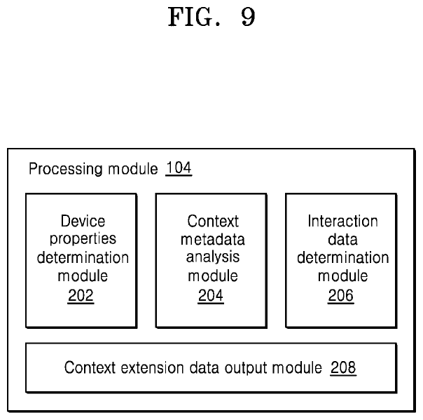

FIG. 9 illustrates a detailed view of a processing module as shown in FIG. 8, comprising various modules, according to embodiments as disclosed herein.

In an embodiment, the apparatus 100 may comprise a processing module 104 stored in the memory unit 102 (as shown in FIG. 8). The processing module 104 may comprise a plurality of sub modules. The plurality of sub modules can comprise of a device properties determination module 202, a context metadata analysis module 204, an interaction data determination module 206, and a context extension data output module 208.

In an embodiment, the device properties determination module 202 is configured to obtain properties of at least one IoT device communicatively connected via a communication network. The properties of at least one IoT device comprises at least one of a status, a content data, a context metadata, a browsing historical data, a search historical data, a usage data, and a device metadata. In an embodiment, the context metadata analysis module 204 is configured to analyze the obtained context metadata associated with the at least one device, based on the obtained properties of the at least one IoT device. In an embodiment, the interaction data determination module 206 is configured to determine an interaction data associated with at least one IoT device based on the analyzed context metadata. The interaction data comprises at least one of a user interaction data with the at least one second device, a user behavioral data and a user gesture data. In an embodiment, the context extension data output module 208 is configured to output a context extension data to perform context aware interaction, by identifying a relevant at least one IoT device to transmit the context extension data, based analyzing at least one of the properties, the context metadata and the interaction data. The outputting comprises at least one of an executing application, executing a context aware interaction.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

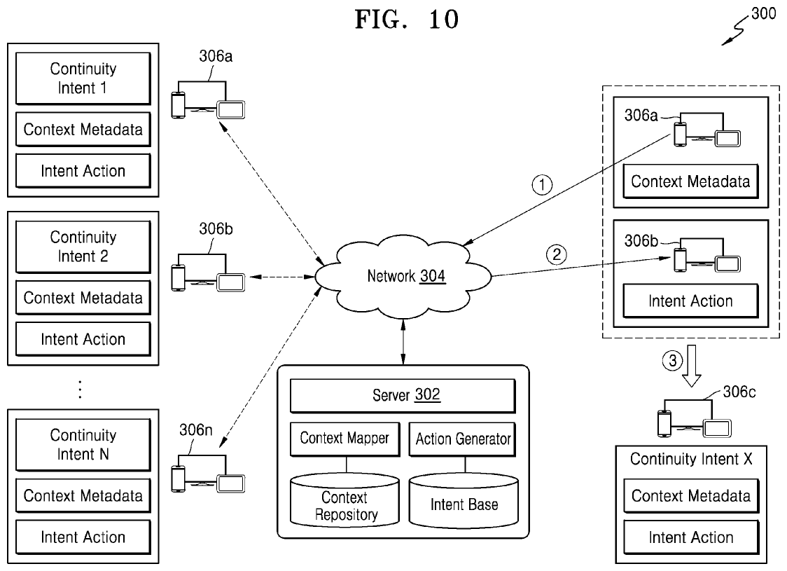

FIG. 10 illustrates a block diagram of a system 300 for managing context aware interaction between Internet of Things (IoT) device(s) 306a-n in the IoT environment, according to embodiments as disclosed herein.

The system may include IoT devices 306a-n, a network 304, and a server 302. The server 302 can be apparatus 100 and the IoT devices 306a-n can be apparatus 100 in the absence of server 302. The server 302 may include sub modules such as a content mapping module, an action generating module. The server may include databases such as context repository and an intent database. The user activity and context from IoT devices 306a-n may be captured and stored in the server 302 via network 304. The captured data may be used to determine context continuity intentions precisely. At a first step, an event is received in an IoT device 306a. At a second step, for any received event and the context on the IoT device 306a, the extended context is determined using information stored in the server 302. At a third step, the user current physical action in an IoT device 306b along with extended intent may be used to continue action with different application.

The system 300 may include a sender device, an invocation mechanism triggering device, and a receiver device. Further, an action list may be included in server 302 or invocation mechanism triggering device or apparatus 100.

Examples of the sender device can be at least one of, but not limited to, a wearable, a smart watch, a heart rate monitor, an earphones, a Virtual Reality (VR) headset, and so on. The invocation mechanism triggering device can be the apparatus 100 or server 302. The invocation mechanism triggering device may determine at least one of, but not limited to, a sensor variations, a proximity device data, and a device state data. Further, the sensor variation data may be used to estimate the interaction with the device. The using NFC (Near Field Communication) or BLE (Bluetooth low Energy) based on proximity of devices (sender/receiver), the proximity device data may be determined. Based on monitoring change in the state of any device via cloud or local hub, the device state may be identified. The action list may comprise at least one of but not limited to, auto launch from notification, context based application launch, auto content transfer, relevant application auto arrangement, application install/sync across devices, easy pairing/connecting devices, and so on. Examples of receiver device can be at least one of but not limited to, smart phone, tablet, laptop/computer, and so on.

Both sender/receiver devices can have respective initial specific state or context. The communication technology can be changed based on industrial standards. The action list allows user to add/remove preferred actions on need basis. In case of multiple actions user can select from the list of possible actions. The sender/receiver device can be a general portable IoT devices 306a-n capable of communicating with each other. In an example, the intent data can be visualized or intimated to the user by a notification, edge item, or temporary footer on navigation panel, and so on. Further, the user may provide feedback for a particular intent data, and the feedback data may be used for generating subsequent context continuity intent.

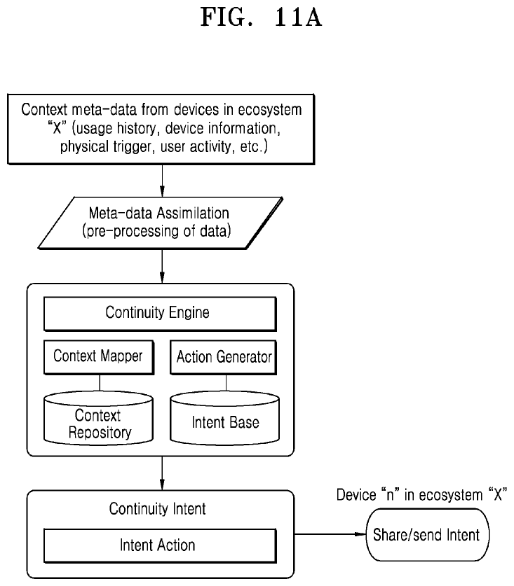

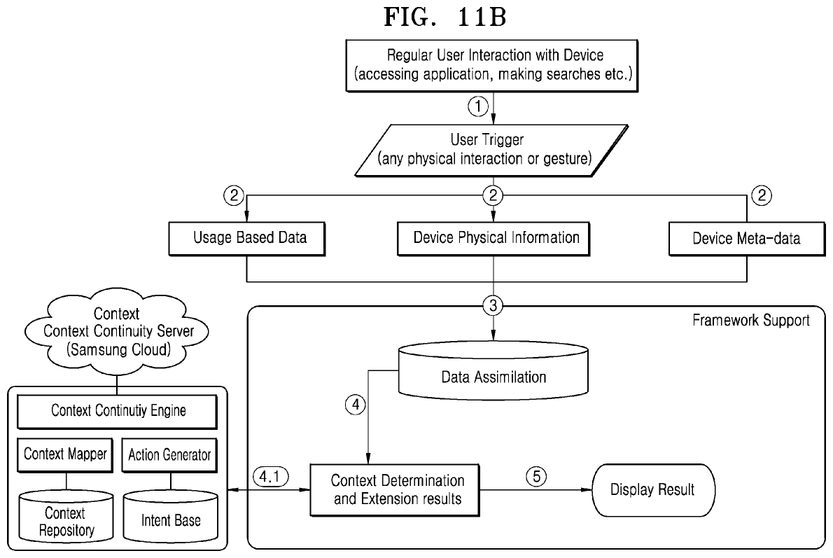

FIG. 11a illustrates a block diagram of method for analyzing context meta-data, according to embodiments as disclosed herein.

The apparatus 100 or server 302 may include sub modules for analyzing context meta-data. The server 302 or apparatus 100 may store the context metadata (such as usage history, device information, physical trigger, user activity, etc.) associated with the user and previously executed intent action. Further, the mapping information may be used along with subsequently received context metadata to derive the subsequent intent action for extending context across the IoT devices 306a-n for a specific user.

FIG. 11b illustrates a block diagram of method for determining regular user interaction with the IoT device, according to embodiments as disclosed herein.

Consider that the user may be interacting with the IoT device 306a-n. In an example, the user interaction may comprise of accessing one or more applications, performing searches, and so on. Further, consider that there is a trigger, which can be the trigger from the user or from any other source. Examples, of the trigger can be any physical interaction, physical gesture, and so on. The data such as usage based data, physical information of the device, device metadata are assimilated by the context continuity engine.

The flow diagram may indicate the process steps that may be performed by the apparatus 100. The apparatus 100 may capture regular interaction (accessing application, performing search, and using subsequent applications) of users with different devices via sensors and stores in apparatus 100 or server 302. Further, if the event is occurred in the IoT device 306a, then the context is determined and extended to another IoT device 306a-n based on the previously stored context and user physical action towards the another IoT device 306a-n, and the current state of the another IoT device 306a-n. Furthermore, the result maybe predicted by the IoT device 306a according to user intent and output to another IoT device 306a-n.

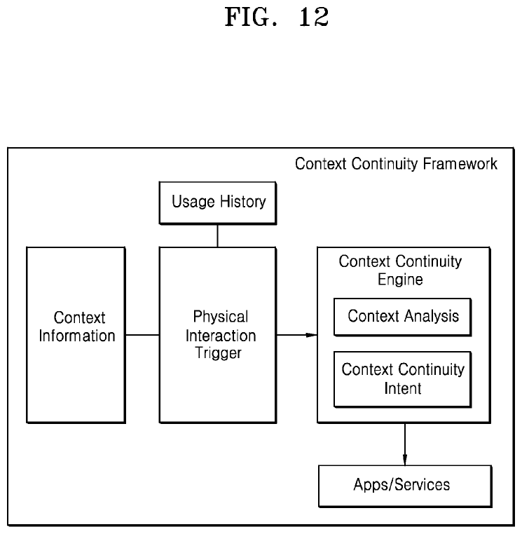

FIG. 12 illustrates a context continuity framework for managing context aware interaction between Internet of Things (IoT) device(s) in the IoT environment, according to embodiments as disclosed herein.

The apparatus 100 may include context continuity framework comprising plurality of modules and sub-modules as shown in FIG. 12. The context information may include at least one of but not limited to, a device state information and a device content/device metadata. The device state information may include at least one of but not limited to, notifications, messages, duration of idle state of IoT devices 306a-n, and so on. The device content/device metadata may include at least one of but not limited to, a context on the current device, a commercial advertisement on television, an advertisement between online video, and so on. Further, a usage history may include at least one of, but not limited to, a browsing history, and an application usage data. The browsing history may include at least one of but not limited to, a cookies, a system cache, and so on. The application usage data may include at least one of, but not limited to, a time spent, a usage pattern, and so on. Furthermore, a physical interaction may include physical interaction with the IoT devices 306a-n. The physical interaction with the IoT devices 306a-n may include at least one of, but not limited to, picking mobile out of a pocket, checking time on smart watch, opening a door, click of home button in mobile to switch application, proximity between IoT devices 306a-n, and so on. A context continuity engine may include a context analysis module and a context continuity intent module. The context analysis module may analyze the IoT environment, extract domain knowledge, and evaluate credibility and relevancy of the context. The context continuity intent module predict subsequent context such as booking the cab, online shopping or purchase, auto fill information, redirecting to a messaging conversation, recharge and bill payment, and so on. An Application and services module can be a module resided in multiple IoT devices 306a-n. The application can include, shopping applications, messaging applications, cab booking applications, recharge and bill payment applications, and so on.

In an example, upon detection of user interest in a particular game along with user activity on any device in the system 300, while reading a blog on the similar line of game, the system 300 may have the capability to book a slot for that particular game in a nearby gaming zone, for the user using any application that enables the service.

In another example, the user may receive message to watch television show. If the user is at home, the smart phone may open the application and display the television show. At the same time if the user points the mobile phone towards television, the same television show may be resuming and played on television.

A method for managing context aware interaction between Internet of Things (IoT) device(s) in an IoT environment, according to embodiments as disclosed herein, is explained.

The method includes obtaining properties of at least one IoT device 306a-n communicatively connected via a communication network 304. In an embodiment, the properties of at least one IoT device 306a-n comprise a context metadata. The method includes analyzing the obtained context metadata associated with the at least one IoT device 306a-n, based on the obtained properties of the at least one IoT device 306a-n. The method includes determining an interaction data associated with at least one IoT device 306a-n based on the analyzed context metadata. In an embodiment, the interaction data comprises at least one of a user interaction data with the at least one IoT device 306a-n, a user behavioral data and a user gesture data. The method includes outputting, by the processor 112, a context extension data to perform context aware interaction, by identifying a relevant at least one IoT device 306a-n to transmit the context extension data, based on analyzing at least one of the properties, the context metadata and the interaction data. In an embodiment, outputting comprises at least one of an executing application executing a context aware interaction.

The various actions in method may be performed in the order presented, in a different order or simultaneously. Further, in some embodiments, some actions may be omitted.

A method for determining a context data and a context extension data, according to embodiments as disclosed herein, is explained.

The method includes identifying periodically, a user trigger data corresponding to at least one of a user interaction and a user gesture, associated with the particular action and particular application. The method includes analyzing at least one of an obtained usage data, a current state information of the at least one IoT device 306a-n, the identified user trigger data, the context metadata of the at least one IoT device 306a-n. The method includes assimilating at least one of the analyzed usage data, the current state information of the at least one IoT device 306a-n, the context metadata, the identified user trigger data, with pre-determined data stored in a database 108. The method includes determining the context data and the context extension data based on the assimilating the analyzed data.

The various actions in method may be performed in the order presented, in a different order or simultaneously. Further, in some embodiments, some actions may be omitted.

A method for generating the context aware interaction to be executed by at least one IoT device, according to embodiments as disclosed herein, is explained.

The method includes assimilating the obtained context metadata with pre-determined data stored in the database 108. The method includes mapping a context intent data corresponding to the context metadata, wherein the context intent data comprises predicting the context aware interaction to be executed by at least one IoT device 306a-n, based on mapping the context intent data with the context metadata. The method includes generating the context aware interaction to be executed by at least one IoT device 306a-n, based on mapping the context intent data corresponding to the context metadata. The method includes outputting the context aware interaction associated with the context intent data.

The various actions in method may be performed in the order presented, in a different order or simultaneously. Further, in some embodiments, some actions may be omitted.

A method for outputting the content data and the context extension data to the second user device based on receiving an input from a first user device, according to embodiments as disclosed herein, is explained.

The method includes receiving an input from an IoT device 306a to another IoT device 306b in the IoT environment, wherein the input is received by another IoT device 306b via a wireless communication interface 304. The method includes determining a content data and the context extension data associated with the IoT device 306a, based on the received input. The method includes outputting the content data and the context extension data to another IoT device 306b, based on the determined content data and the context extension data.

The various actions in method may be performed in the order presented, in a different order or simultaneously. Further, in some embodiments, some actions may be omitted.

Embodiments herein may dynamically predict actions based on current context and physical user interaction, intelligently predict the best possible next action of the user, and analyze the contextual information, usage history and physical interaction to generate/produce context continuity intent. Embodiments herein may handle complex scenarios with multiple constraints across devices considering intention of the user and current context.

Embodiments herein may resume the context by providing necessary details to another device or application in use, from the previous task/application/device/activity, to maintain a seamless experience while switching. Embodiments herein shall reduce turnaround time and cognitive load on the user. Embodiments herein may reduce the modality of interactions for end-user by intelligently bypassing few steps such as finding the application on device, application launch, filling required information, and so on.

Embodiments herein enable circumvention of the manual process of switching across the devices and then taking the context further based on mental assimilation of details by the user. Embodiments herein continue the context further and automatically navigate to the next possible device state. Embodiments herein support the intent to work across the applications. Embodiments herein require only a general physical interaction at the right time to trigger the intent.

The embodiments disclosed herein can be implemented through at least one software program running on at least one hardware device and performing network management functions to control the elements. The elements shown in FIG. 1 can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

According to an embodiment, there is provided a method (700a) for managing context aware interaction between at least one IoT (Internet of Things) device (306a-n) in an IoT environment comprising:

obtaining, by a processor (112), properties of at least one IoT device (306a-n) communicatively connected via a communication network (304), wherein the properties of at least one IoT device (306a-n) comprise a context metadata;

analyzing, by the processor (112), the obtained context metadata associated with the at least one IoT device (306a-n), based on the obtained properties of the at least one IoT device (306a-n), wherein the context metadata comprises at least one of a usage history, a device information, a physical trigger, a notification content, a task data, and a user activity;

determining, by the processor (112), an interaction data associated with at least one IoT device (306a-n) based on the analyzed context metadata, wherein the interaction data comprises at least one of, a plurality of users interaction data with the at least one IoT device (306a-n), a user behavioral data and a user gesture data; and

outputting, by the processor (112), a context extension data to perform context aware interaction, by identifying a relevant at least one IoT device (306a-n) to transmit the context extension data, based on analyzing at least one of the properties, the context metadata and the interaction data, wherein outputting comprises at least one of an executing application, executing a context aware interaction.

In an embodiment, the method (700b) further comprises:

identifying, by the processor (112), periodically, a user trigger data corresponding to at least one of a user interaction and a user gesture, associated with the particular action and particular application;

analyzing, by the processor (112), at least one of an obtained usage data, a current state information of the at least one IoT device (306a-n), the identified user trigger data, the context metadata of the at least one IoT device (306a-n);

assimilating, by the processor (112), at least one of the analyzed usage data, the current state information of the at least one IoT device (306a-n), the context metadata the identified user trigger data, with pre-determined data stored in a database (108); and

determining, by the processor (112), the context data and the context extension data based on the assimilating the analyzed data.

In an embodiment, the method (700c) further comprises:

assimilating, by the processor (112), the obtained context metadata with pre-determined data stored in the database (108);

mapping, by the processor (112), a context intent data corresponding to the context metadata, wherein the context intent data comprises predicting the context aware interaction to be executed by at least one IoT device (306a-n), based on mapping the context intent data with the context metadata;

generating, by the processor (112), the context aware interaction to be executed by at least one IoT device (306a-n), based on mapping the context intent data corresponding to the context metadata; and

outputting, by the processor (112), the context aware interaction associated with the context intent data.

In an embodiment, the method (700d) further comprises:

receiving, by the processor (112), an input from a IoT device (306a) to another IoT device (306b) in the IoT environment, wherein the input is received by the another IoT device (306b) via a wireless communication interface (304);

determining, by the processor (112), a content data and the context extension data associated with the IoT device (306a), based on the received input; and

outputting, by the processor (112), the content data and the context extension data to another IoT device (306b), based on the determined content data and the context extension data.

In an embodiment, the properties of the at least one IoT device (306a-n) comprises a status, a current state, a notifications, a text message, a device metadata, and a duration of idle state of the at least one IoT device (306a-n).

In an embodiment, the user behavioral data comprises at least one of an accessing the application, a search historical data, a browsing historical data, a subsequent application usage, a usage data, and a substitute application usage.

In an embodiment, the user trigger data comprises the user interaction for a particular event corresponding to at least one of the notification, the text message, the commercial advertisement, a phone call, an ecommerce shopping, a bill payment, a cab booking, a holiday booking and a movie booking.

In an embodiment, assimilating comprises comparing the previously obtained properties with the currently obtained properties by sequential time-stepping.

In an embodiment, outputting comprises causing another IoT device (306b) to resume the context aware interaction and pre-fill the required details.

In an embodiment, the content data, the context metadata and the device metadata comprises at least one of a context data, a media data, and an advertisement data; wherein the usage data comprises, a duration of usage of an application, a usage pattern of the application.

According to an embodiment, there is provided a method for managing context aware interaction between at least one IoT (Internet of Things) device (306a-n) in an IoT environment comprising:

determining, by a first IoT device (306a-n), at least one trigger parameter is received at a first IoT device (306a-n), wherein the at least one trigger parameter comprises at least one of a notification, an advertisement, and a triggered transaction;

analyzing, by the first IoT device (306a-n), a context metadata of the first IoT device (306a-n) and a second IoT device (306a-n), based on receiving the at least one trigger parameter, wherein the context metadata comprises at least one of a usage history, a device information, a physical trigger, a notification content, a task data, a context data and a user activity;

identifying, by the first IoT device (306a-n), an interaction data and a physical interaction trigger associated with the second IoT device (306a-n), in response to receiving at least one trigger parameter, wherein the interaction data comprises at least one of a gesture, a usage based data, a device information, and a device metadata, wherein the physical interaction trigger comprises at least one of a sensor variations, a proximity data, and a device state;

determining, by the first IoT device (306a-n), an intent action of a plurality of users with the second IoT device (306a-n), in response to receiving the at least one trigger parameter, based on identifying the interaction data and the physical interaction trigger associated with the second IoT device (306a-n), wherein the intent action comprises at least one of a launching application, a closing application, a switch between application, an unlocking the IoT device (306a-n) and the physical interaction trigger with the IoT device (306a-n); and

outputting, by the first IoT device (306a-n), a context extension data to the second IoT device (306a-n) for performing context aware interaction, based on determining the intent action, wherein outputting context extension data to the second IoT device (306a-n) comprises executing at least one of an executing application, executing a context aware interaction, in the second IoT device (306a-n).

According to an embodiment, there is provided an apparatus (100) for managing context aware interaction between at least one IoT (Internet of Things) device (306a-n) in an IoT environment comprising:

a processor (112); and

a memory unit (102) coupled to the processor (112), wherein the memory unit (102) comprises a processing module (104) configured to:

obtain properties of at least one IoT device (306a-n) communicatively connected via a communication network (304), wherein the properties of at least one IoT device (306a-n) comprise a context metadata;

analyze the obtained context metadata associated with the at least one IoT device (306a-n), based on the obtained properties of the at least one IoT device (306a-n);

determine an interaction data associated with at least one IoT device (306a-n) based on the analyzed context metadata, wherein the interaction data comprises at least one of a user interaction data with the at least one IoT device (306a-n), a user behavioral data and a user gesture data; and

output a context extension data to perform context aware interaction, by identifying a relevant at least one IoT device (306a-n) to transmit the context extension data, based on analyzing at least one of the properties, the context metadata and the interaction data, wherein outputting comprises at least one of an executing application executing a context aware interaction.

According to an embodiment, there is provided an apparatus (100) for managing context aware interaction between at least one IoT (Internet of Things) device (306a-n) in an IoT environment comprising:

a processor (112); and

a memory unit (102) coupled to the processor (112), wherein the memory unit (102) comprises a processing module (104) configured to:

determine, by a first IoT device (306a-n), at least one trigger parameter is received at a first IoT device (306a-n), wherein the at least one trigger parameter comprises at least one of a notification, an advertisement, and a triggered transaction;

analyze, by the first IoT device (306a-n), a context metadata of the first IoT device (306a-n) and a second IoT device (306a-n), based on receiving the at least one trigger parameter, wherein the context metadata comprises at least one of a usage history, a device information, a physical trigger, a notification content, a task data, a context data and a user activity;

identify, by the first IoT device (306a-n), an interaction data and a physical interaction trigger associated with the second IoT device (306a-n), in response to receiving at least one trigger parameter, wherein the interaction data comprises at least one of a gesture, a usage based data, a device information, and a device metadata, wherein the physical interaction trigger comprises at least one of a sensor variations, a proximity data, and a device state;

determine, by the first IoT device (306a-n), an intent action of a plurality of users with the second IoT device (306a-n), in response to receiving the at least one trigger parameter, based on identifying the interaction data and the physical interaction trigger associated with the second IoT device (306a-n), wherein the intent action comprises at least one of a launching application, a closing application, a switch between application, an unlocking the IoT device (306a-n) and the physical interaction trigger with the IoT device (306a-n); and

output, by the first IoT device (306a-n), a context extension data to the second IoT device (306a-n) for performing context aware interaction, based on determining the intent action, wherein outputting context extension data to the second IoT device (306a-n) comprises executing at least one of an executing application, executing a context aware interaction, in the second IoT device (306a-n).

One embodiment of the present disclosure may be implemented in a form of a recording medium including computer-executable instructions such as a program module executed by a computer system. A computer-readable medium may be an arbitrary available medium which may be accessed by a computer system and includes all types of volatile and non-volatile media and separated and non-separated media. In addition, the computer-readable medium may include computer storage media and communication media. The computer storage media include all types of volatile and nonvolatile and separated and non-separated media implemented by an arbitrary method or technique for storing information such as computer-readable instructions, a data structure, a program module, or other data. The communication media may typically include computer-readable instructions, a data structure, or other data of a modulated signal such as a program module. In addition, the database used in the present disclosure may be recorded in the recording medium.

The present disclosure has been particularly described with reference to preferred embodiments shown in the drawings. These embodiments are only illustrative without limiting the present disclosure and should be considered in descriptive sense only and not for purposes of limitation. It will be understood by those of ordinary skill in the art that various changes in form and details may be made in the embodiments without changing the technical spirit and mandatory features of the present disclosure. For example, each component described as a single type may be carried out by being distributed, and likewise, components described as a distributed type may also be carried out by being coupled.

Although specific terms are used in the specification, the terms are only used to describe the concept of the present disclosure and not for purposes of limiting the meaning or the scope of the present disclosure in the claims. Each operation in the present disclosure does not have to be necessarily performed in the disclosed order but may be performed in parallel, selectively, or individually.

The true technical scope of the present disclosure for which protection is sought should be defined not by the above description but by the technical idea of the following claims, and it should be analysed that the meaning and the scope of the claims and all changes or modifications derived from equivalent concepts thereof are included in the scope of the present disclosure. It should be understood that equivalents include not only currently known equivalents but also equivalents to be developed in the future, that is, all components disclosed to perform the same functions regardless of a structure.

1. A context extension apparatus for context extension between Internet of Things (IoT) devices, the context extension apparatus comprising:
a memory storing one or more instructions; and
at least one processor configured to execute the one or more instructions stored in the memory,
wherein the at least one processor is further configured to:
receive context information from a context information generation apparatus,
determine a context extension action based on the received context information and a context extension trigger event in response to an occurrence of the context extension trigger event, and
allow the determined context extension action to be performed.

2. The context extension apparatus of claim 1, wherein the at least one processor is further configured to receive the context information from the context information generation apparatus other than a device in which the context extension trigger event occurred.

3. The context extension apparatus of claim 1, wherein the at least one processor is further configured to:
receive respective pieces of context information from a plurality of context information generation apparatuses; and
determine the context extension action based on a relationship between the pieces of context information respectively received from the plurality of context information generation apparatuses.

4. The context extension apparatus of claim 1, wherein the at least one processor is further configured to:
generate context extension information including information about the context extension action;
determine an IoT device that is to perform the context extension action; and
transmit the context extension information to the determined IoT device such that the determined context extension action is performed.

5. The context extension apparatus of claim 4, wherein the at least one processor is further configured to:
determine a plurality of IoT devices that are to perform the context extension action in a linked manner; and
transmit the context extension information to at least one of the determined plurality of IoT devices.

6. The context extension apparatus of claim 1, wherein the at least one processor is further configured to:
receive use history information of a device other than the context information generation apparatus; and
determine the context extension action based on a relationship between the context information and the use history information.

7. The context extension apparatus of claim 1, wherein the at least one processor is further configured to determine the context extension action based on matching information among context information, context extension trigger events, and context extension actions stored in a database.

8. The context extension apparatus of claim 7, wherein the at least one processor is further configured to update the database based on the context information received from the context information generation apparatus, the generated context extension trigger event, and an actually performed action.

9. The context extension apparatus of claim 1, wherein the at least one processor is further configured to receive the context information broadcast by the context information generation apparatus.

10. The context extension apparatus of claim 1, wherein the at least one processor is further configured to receive the context information by receiving, via short-range communication, context information transmitted from devices positioned nearby.

11. The context extension apparatus of claim 1, wherein the context information generation apparatus is not registered to a same user as a device in which the context extension trigger event has occurred.

12. The context extension apparatus of claim 4, wherein the IoT device that is to perform the context extension action is not registered to a same user as the context information generation apparatus.

13. The context extension apparatus of claim 1, wherein an application related to the context information differs from an application related to the context extension action.

14. The context extension apparatus of claim 1, wherein the at least one processor is further configured to determine the context extension action based on a time point related to the context information and a time point related to the context extension trigger event.

15. The context extension apparatus of claim 1, wherein the at least one processor is further configured to determine a context extension trigger event to be detected, according to the received context information and the context extension action related to the context information.

16. A context information generation apparatus for context extension between Internet of Things (IoT) devices, the context information generation apparatus comprising:
a memory storing one or more instructions; and
at least one processor configured to execute the one or more instructions stored in the memory,
wherein the at least one processor is further configured to:
generate context information based on a current state of the context information generation apparatus, and
transmit the generated context information to a context extension apparatus.

17. The context information generation apparatus of claim 16, wherein the at least one processor is further configured to transmit the generated context information to the context extension apparatus by broadcasting the context information to nearby IoT devices via short-range communication.

18. The context information generation apparatus of claim 17, wherein the at least one processor is further configured to repetitively broadcast the context information to the nearby IoT devices.

19. An operating method of a context extension apparatus for context extension between Internet of Things (IoT) devices, the operating method comprising:
receiving context information from a context information generation apparatus;
determining a context extension action based on the received context information and a context extension trigger event in response to an occurrence of the context extension trigger event; and
allowing the determined context extension action to be performed.

20. An operating method of a context information generation apparatus for context extension between Internet of Things (IoT) devices, the operating method comprising:
generating context information based on a current state of the context information generation apparatus; and
transmitting the generated context information to a context extension apparatus.
